(19) United States
(12) Patent Application Publication
(10) Pub. No.: US 2019/0249043 A1
(43) Pub. Date: Aug. 15, 2019

(54) ADHESIVE COMPOSITIONS

(71) Applicant: CELANESE INTERNATIONAL CORPORATION, Irving, TX (US)

(72) Inventors: Alistair MCLENNAN, Königstein (DE); Hans Uwe FAUST, Liederbach (DE)

(21) Appl. No.: 15/895,559

(22) Filed: Feb. 13, 2018

(51) Int. Cl. C09J 131/02; C09J 4/06

(52) U.S. Cl. CPC C09J 131/02; C09J 2429/001; C09J 4/06

(57) ABSTRACT

An adhesive composition comprises a copolymer dispersion prepared by a free radical emulsion polymerization process, in which a first monomer composition comprising from 60 weight percent to 95 weight percent of at least one vinyl ester of a C₁ to C₁₈ carboxylic acid, and from 5 weight percent to 40 weight percent ethylene is polymerized in a first stage to produce a first polymer phase having a glass transition temperature T_{g} less or equal than 30° C. A second, different monomer composition comprising from 5 weight percent to 95 weight percent of at least one vinyl ester of a C₁ to C₁₈ carboxylic acid and from 5 weight percent to 95 weight percent 2-ethylhexyl acrylate is then polymerized in a second stage, and in the presence of the first polymer phase, to produce a second polymer phase also having a glass transition temperature T_{g} less than or equal to 30° C.

### FIELD

The present invention relates to adhesive compositions, particularly for use with low surface energy substrates.

### BACKGROUND

Aqueous dispersions containing vinyl ester polymers have widespread applications in the field of adhesives and coatings. For example, stabilized aqueous polymer dispersions containing vinyl acetate polymers have applications as adhesives for paper packaging and converting, woodworking, vinyl laminating, woven and non-woven fabrics, films, metallic foils and metallized films, as well as flexible cellular materials such as polyurethane foams or sponge rubber. The adhesives are often prepared with polymers synthesized using emulsion polymerization. On evaporation or removal of the aqueous medium, the compositions cure or harden at room temperature to form a film which is desirably characterized by high strength and flexibility and resistance to heat, and humidity. Some examples of aqueous adhesive compositions comprising vinyl acetate emulsion polymers can be found in U.S. Pat. Nos. 5,571,860 and 6,762,239.

For certain applications, particularly in adhering to low surface energy substrates, such as polyethylene and oriented polypropylene films, frequently encountered in packaging of foods and other commodities, it is customary to add an external plasticizer to vinyl ester-based adhesive compositions to ensure a satisfactory level of adhesion. Typical plasticizers employed in such applications include benzoate esters and may be added in concentrations from 5 to 20% by weight of vinyl ester to achieve the right balance of flexibility, bond strength, and minimum film formation temperature. However, particularly when used at such high levels, such plasticizers increase the migration potential of undesirable compounds out of the adhesive layer and into the bonded material (or the packaged material itself). Therefore, the utilization of such plasticizers for food contact materials is restricted.

To avoid the need for external plasticizers, it is known to add 2-ethylhexyl acrylate to vinyl acetate copolymers to increase their adhesive strength. For example, U.S. Pat. No. 4,322,516 discloses a copolymer having a glass transition temperature from −20° C. to −60° C. useful as a pressure-sensitive adhesive and produced from an aqueous dispersion comprising: (a) from 10% to 30% by weight of ethylene units, (b) from 29% to 69% by weight of acrylic ester units, preferably 2-ethylhexyl acrylate, (c) from 20% to 55% by weight of vinyl acetate units, (d) from 0.2% to 8% by weight of (meth)acrylamide units, and (e) from 0 to 12% of other olefinically-unsaturated monomer units copolymerizable with the above. However, the high levels of 2-ethylhexyl acrylate required to achieve satisfactory adhesive strength with low surface energy (non-polar) substrates makes these terpolymers expensive and, in many cases, difficult to manufacture.

There is therefore significant interest in developing new vinyl ester based adhesives which can be used to bond to low surface energy substrates, especially oriented polypropylene films, without the need for external plasticizers.

It is known from, for example, U.S. Pat. No. 6,706,805 that building materials containing copolymers derived from vinyl ester, (meth)acrylic ester and optionally ethylene comonomers, stabilized with a polyvinyl alcohol protective colloid, as their aqueous dispersions or as redispersible polymer powders which are redispersible in water, can be produced by emulsion or suspension copolymerization in an at least two step process wherein a) the vinyl ester component is polymerized, optionally with ethylene, to a conversion of from 90 to 100% by weight in a first step, and b) the ester(s) of (meth)acrylic acid are subsequently added and polymerized in a second step. The esters of (meth)acrylic acid are copolymerized in an amount of from 1 to 70% by weight, preferably from 5 to 40% by weight, based on the total weight of all comonomers.

U.S. Pat. No. 8,993,668 discloses polyvinyl ester dispersions which are useful as emulsion paints and which are produced by multistage free-radical emulsion polymerization of at least one vinyl ester of a straight-chain or branched aliphatic saturated carboxylic acid having a carbon chain length of from C₁ to C₁₈ and optionally further monomers copolymerizable therewith in a first stage and of at least one different free-radically polymerizable monomer in a second stage in the presence of a protective colloid, an emulsifier, or mixtures thereof, wherein the at least one different free-radically polymerizable monomer is selected from the group consisting of a vinyl aromatic and an ester of an ethylenically unsaturated mono- or dicarboxylic acid.

US Patent Application Publication No. 2005/0107527 discloses an aqueous polymer dispersion useful in coating compositions that exhibit improved block resistance and including a multi-stage emulsion polymer made by a process that includes a first polymerization stage, in which a first monomer mixture having a calculated glass transition temperature of at least about 50° C. is polymerized via free radical emulsion polymerization to obtain a first-stage emulsion polymer, and a second polymerization stage, in which a second monomer mixture having a calculated glass transition temperature from about −30° C. to about 10° C. is polymerized via free radical emulsion polymerization, in the presence of the first-stage emulsion polymer.

### SUMMARY

According to the present invention, it has now been found that an adhesive composition which exhibits excellent adhesion to low energy substrates, such as oriented polypropylene films, without the addition of external plasticizers can be produced by a multi-stage free radical emulsion polymerization process in which a vinyl ester and ethylene are polymerized in a first stage and then a vinyl ester and 2-ethylhexyl acrylate are polymerized in a second stage in the presence of the first-stage polymer.

In one aspect, the invention resides in an adhesive composition comprising a copolymer dispersion prepared by a free radical emulsion polymerization process comprising:

(a) polymerizing, in a first stage and under ethylene pressure, a first monomer composition comprising from 60 weight percent to 95 weight percent of at least one vinyl ester of a C₁ to C₁₈ carboxylic acid, and from 5 weight percent to 40 weight percent ethylene to produce a first stage polymer having a glass transition temperature T_{g} of less or equal than 30° C.; and

(b) polymerizing, in a second stage and in the presence of the first stage polymer, a second, different monomer composition comprising from 5 weight percent to 95 weight percent of at least one vinyl ester of a C₁ to C₁₈ carboxylic acid, and from 5 weight percent to 95 weight percent 2-ethylhexyl acrylate such that the polymer produced by the second monomer composition has a glass transition temperature T_{g} of less than or equal to 30° C.

### DETAILED DESCRIPTION

Described herein is an adhesive composition, suitable for adhering to low energy substrates, such as polyethylene and oriented polypropylene films, comprising a copolymer dispersion which is prepared by a multi-stage free radical induced emulsion polymerization process and which comprises particles comprising at least a first polymer phase formed from a first monomer composition and a second polymer phase from a second, different monomer composition. Although formed from different monomer compositions, both the first and second polymer phases have a glass transition temperature, T_{g}, of less than or equal to 30° C. The first polymer phase typically has a glass transition temperature, Tg, preferably from −35° C. to 25° C., more preferably from −35° C. to 10° C. The second polymer phase typically has a glass transition temperature, Tg, preferably from −70° C. to 25° C., more preferably from −70° C. to 0° C.

All glass transition temperature values cited herein are as measured according to ASTM E 1356 by Differential Scanning calorimetry, (DSC), using a Mettler DSC 820 with a fluid N₂ cooling system. The tested range is from −80° C. to 130° C. with a heating rate of 10° C./min The mid-point Tg is quoted.

### First Monomer Composition

The first monomer composition comprises, as main monomers, from 60 weight percent to 95 weight percent, preferably from 60 weight percent to 85 weight percent, of at least one vinyl ester of a C₁ to C₁₈ carboxylic acid and from 5 weight percent to 40 weight percent, preferably from 15 weight percent to 40 weight percent, ethylene, both percentages being based on the total weight of main monomers in the first monomer composition.

Examples of suitable vinyl esters of C₁ to C₁₈ carboxylic acids include vinyl acetate, vinyl propionate, vinyl butyrate, vinyl laurate, 1-methylvinyl acetate, vinyl pivalate, and vinyl esters of branched monocarboxylic acids having 5 to 15 carbon atoms, generally 8 to 13 carbon atoms, and whose homopolymer has a glass transition temperature, Tg, less than 0° C. Examples of such monomers (iii) include vinyl 2-ethylhexanoate, vinyl esters of α-branched monocarboxylic acids having 10 or 11 carbon atoms, such as VeoVa10® and VeoVa11®, and vinyl esters of branched monocarboxylic acids having 10 to 13 carbon atoms, such as Exxar Neo12. Particularly preferred is vinyl acetate.

In addition to the main monomers described above, the first monomer composition may comprise up to 10 weight %, such as 0.1 to 2 weight %, typically 0.5 to 1.5 weight % [based on the total weight of the main monomers] of at least one ethylenically unsaturated monocarboxylic or dicarboxylic acid having 3 to 4 carbon atoms. Examples of suitable comonomers (iv) comprise acrylic acid, methacrylic acid, itaconic acid, fumaric acid, and maleic acid, with acrylic and methacrylic acids being preferred.

Additionally or alternatively, the first monomer composition may comprise up to 10 weight %, such as 0.1 to 2 weight %, typically 0.5 to 1.5 weight % [based on the total weight of the main monomers] of at least one methacrylic or acrylic acid ester modified with one or more groups selected from epoxide groups and hydroxyl groups. Examples of suitable epoxy modified esters include glycidyl methacrylate and glycidyl acrylate. Examples of suitable hydroxyl modified esters include hydroxyalkyl esters having a C₁ to C₅ alkyl radical such as hydroxyethyl, hydroxypropyl or hydroxybutyl acrylate or methacrylate. The preferred comonomer is glycidyl methacrylate.

Optionally, the monomer mixture also includes up to 10 weight %, such as from 0.01 to 5 weight %, preferably 0.2 to 1.5 weight %, again based on the total weight of the main monomers, of one or more further mono- or poly-ethylenically unsaturated comonomers (vi). Examples of suitable comonomers (vi) include functional comonomers, such as ethylenically unsaturated carboxamides and carbonitriles, for example acrylamide and acrylonitrile; monoesters and diesters of fumaric acid and maleic acid, such as the diethyl and diisopropyl esters and also maleic anhydride; ethylenically unsaturated sulfonic acids and their salts, preferably vinylsulfonic acid, 2-acrylamido-2-methylpropanesulfonic acid. Further examples are pre-crosslinking comonomers, such as polyethylenically unsaturated comonomers, for example divinyl adipate, diallyl maleate, allyl methacrylate and triallyl cyanurate and post-crosslinking comonomers, such as N-methylolacrylamide (NMA), N-methylolmethacrylamide, alkyl esters such as the isobutyoxy ether or esters of N-methylolacrylamide. Also suitable are are silicon-functional comonomers, such as acryloxypropyltri(alkoxy)- and methacryloxypropyltri(alkoxy)-silanes, vinyltrialkoxysilanes, and vinylmethyldialkoxysilanes.

### Second Monomer Composition

The second monomer composition comprises, as main monomers, from 5 weight percent to 95 weight percent, preferably from 5 weight percent to 75 weight percent, of at least one vinyl ester of a C₁ to C₁₈ carboxylic acid and from 5 weight percent to 95 weight percent, preferably from 25 weight percent to 95 weight percent, of 2-ethylhexyl acrylate, both percentages being based on the total weight of main monomers in the second monomer composition.

As in the case of the first monomer composition, suitable vinyl esters of C₁ to C₁₈ carboxylic acids for use in the second monomer composition include vinyl acetate, vinyl propionate, vinyl butyrate, vinyl laurate, 1-methylvinyl acetate, vinyl pivalate, and vinyl esters of branched monocarboxylic acids having 5 to 15 carbon atoms, generally 8 to 13 carbon atoms, and whose homopolymer has a glass transition temperature, Tg, less than 0° C. Examples of such monomers (iii) include vinyl 2-ethylhexanoate, vinyl esters of a-branched monocarboxylic acids having 10 or 11 carbon atoms, such as VeoVa10® and VeoVa11®, and vinyl esters of branched monocarboxylic acids having 10 to 13 carbon atoms, such as Exxar Neo12. Particularly preferred is vinyl acetate.

In addition, the second monomer composition may include the same optional comonomers, in the same amounts as discussed above, as the first monomer composition. In one preferred embodiment, the second monomer compositions comprises from 0.05 weight percent to about 2 weight percent of at least one ethylenically unsaturated carboxylic acid, especially acrylic or methacrylic acid. The second monomer composition does not normally contain ethylene, although there may be unpolymerised ethylene in the reactor at the start of the second polymerization phase.

In some embodiments, the first monomer composition comprises at least 75 weight percent, such as from 75 to 95 weight percent of the total of the first and second monomer compositions.

### Dispersion Stabilization System

Both during and after polymerization, the multi-stage polymer described herein is stabilized in the form of an aqueous copolymer dispersion or latex. The copolymer dispersion is therefore prepared in the presence of and subsequently contains a stabilization system which generally comprises a protective colloid and one or both of a non-ionic and an anionic surfactant. Generally the protective colloid is present in an amount from 0.01 to 3 weight %, such as from 0.05 to 2 weight %, whereas the non-ionic surfactant is present in an amount from 0.01 to 5 weight %, such as from 0.5 to 4 weight % and the anionic surfactant is present in an amount from 0.01 to 5 weight %, such as from 0.05 to 2 weight %, wherein all weight % are based on the total weight of the monomers in the first and second momomer compositions. The weight ratio of the non-ionic to anionic surfactants may fluctuate within wide ranges, such as between 1:1 and 50:1, generally between 1:1 and 10:1.

Examples of suitable nonionic emulsifiers include acyl, alkyl, oleyl, and alkylaryl ethoxylates. These products are commercially available, for example, under the name Genapol®, Lutensol®, Rhodasurf®, Emulsogen® or Emulan®. They include, for example, ethoxylated fatty alcohols (EO degree: 3 to 80; alkyl radical: C₈ to C₃₆), especially C₁₁ linear or branched alcohol (3-40) ethoxylates, C₁₂-C₁₄ fatty alcohol (3-40) ethoxylates, C₁₃-C₁₅ oxo-process alcohol (3-40) ethoxylates, C₁₆-C₁₈ fatty alcohol (11-80) ethoxylates, C₁₀ oxo-process alcohol (3-40) ethoxylates, C₁₃ oxo-process alcohol (3-40) ethoxylates, polyoxyethylene sorbitan monooleate with 20 ethylene oxide groups, copolymers of ethylene oxide and propylene oxide having a minimum ethylene oxide content of 10% by weight, the polyethylene oxide (4-40) ethers of oleyl alcohol, and the polyethene oxide (4-40) ethers of nonylphenol. Particularly suitable are the polyethylene oxide (4-40) ethers of C₁₀ to C₁₆ alkyl alcohols.

Examples of suitable anionic emulsifiers include sodium, potassium, and ammonium salts of linear and branched aliphatic carboxylic acids of chain length C₁₂-C₂₀, sodium hydroxyoctadecanesulfonate, sodium, potassium, and ammonium salts of hydroxy fatty acids of chain length C₁₂-C₂₀ and their sulfonation and/or sulfation and/or acetylation products, alkyl sulfates, including those in the form of triethanolamine salts, alkyl(C₁₀-C₂₀) sulfonates, alkyl(C₁₀-C₂₀) arylsulfonates, dimethyl-dialkyl (C₈-C₁₈) ammonium chloride, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium lauryl sulfate, sulfated alkyl or aryl ethoxylate with EO degree between 1 and 10, for example ethoxylated sodium lauryl ether sulfate (EO degree 3) or a salt of a mono- or diester, preferably C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of mono- or di-C₄-C₁₈ alkyl esters of sulfonated succinic acid, or phosphates of polyethoxylated alkanols or alkylphenols.

Examples of suitable protective colloids include water-soluble or water-dispersible polymeric modified natural substances, such as cellulose ethers, examples being methyl, ethyl-, hydroxyethyl- or carboxymethylcellulose; water-soluble or water-dispersible polymeric synthetic substances, such as polyvinylpyrrolidone or polyvinyl alcohols or their copolymers (with or without residual acetyl content), and polyvinyl alcohol which is partially esterified or acetalized or etherified with saturated radicals, and also with different molecular weights. Preferably, the protective colloid is a cellulose ether, particularly hydroxyethylcellulose, or polyvinyl alcohol.

In addition to the emulsifiers and protective colloids that are used during the emulsion polymerization of the copolymers herein, it is also possible to add further emulsifiers, protective colloids and/or other stabilizers after the polymerization.

### Preparation of the Polymer Dispersion

The desired copolymer dispersion is produced by multi-stage emulsion polymerization of the monomers and stabilizing system described above in an aqueous medium and in the presence of one or more free radical initiators. Suitable free radical initiators include hydrogen peroxide, benzoyl peroxide, cyclohexanone peroxide, isopropyl cumyl hydroperoxide, persulfates of potassium, of sodium and of ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The abovementioned compounds can also be used within redox systems, using transition metal salts, such as iron(II) salts, as a catalyst. Alkali metal salts of oxymethanesulfinic acid, hydroxylamine salts, sodium dialkyldithiocarbamate, sodium bisulfite, ammonium bisulfite, sodium dithionite, diisopropyl xanthogen disulfide, ascorbic acid, tartaric acid, and isoascorbic acid and their sodium or potassium salts can be used as reducing agents.

The multi-stage emulsion polymerization may be carried out in accordance with the customary techniques of emulsion polymerization. Preferably, the process is carried out by first emulsifying and then polymerizing the first monomer composition in an aqueous phase in the presence of emulsifiers, initiators and, if desired, protective colloids, at suitable temperatures of, for example from 50 to 105° C., preferably 65 to 95° C., to produce a first polymer phase. Subsequently, the second monomer composition is polymerized in a second stage in the aqueous phase in the presence of the first polymer phase as well as emulsifiers, initiators and, if desired, protective colloids, at suitable temperatures of, for example, from 50 to 85° C., preferably 55 to 80° C., to produce the second polymer phase and thereby to obtain polymer particles comprising the first and second polymer phases. A variety of particle morphologies may be obtained, ranging from core-shell to Janus and raspberry structures. In case of a core-shell morphology, the first polymer phase does not necessarily correspond to the core phase of the polymer particle.

In some embodiments, it may be desirable to pre-polymerize a small amount (less than 20 weight %) of the first monomer composition to produce an in-situ seed before the remaining amounts of the first monomer composition and the second monomer composition are sequentially metered into the reactor to form the final polymer dispersion.

On completion of the polymerization, a further, preferably chemical after-treatment, especially with redox initiators, for example combinations of the above-mentioned oxidizing agents and reducing agents, may follow to reduce the level of residual unreacted monomer in the product. In addition, residual monomer and non-polymerizable VOC's can be removed in known manner, for example by physical demonomerization, i.e. distillative removal, especially by means of steam distillation, or by stripping with an inert gas. A particularly efficient combination is one of physical and chemical methods, which permits lowering of the residual monomers to very low contents (<1000 ppm, preferably <100 ppm).

The copolymer dispersions as prepared herein will generally have a viscosity of at least 100 mPas, such as about 100 mPas to about 10000_mPas at 50 to 60% solids and 25° C., as measured with a Brookfield viscometer at 20 rpm, with appropriate spindle. Viscosity may be adjusted by the addition of thickeners and/or water to the copolymer dispersion. Suitable thickeners can include polyacrylates or polyurethanes, such as Borchigel L75® and Tafigel PUR 60®. Alternatively, the copolymer dispersion may be substantially free of thickeners.

Following polymerization, the solids content of the resulting aqueous copolymer dispersions can be adjusted to the level desired by the addition of water or by the removal of water by distillation. Generally, the desired level of polymeric solids content after polymerization is from about 30 weight percent to about 70 weight percent based on the total weight of the polymer dispersion, more preferably from about 50 weight percent to about 65 weight percent. Prior to use the present copolymer dispersion can be spray dried to produce a redispersible powder.

The copolymer dispersion described herein can be used in a variety of applications, such as in adhesives, caulks, and sealants. The dispersion is, however, particularly intended for use in adhesive formulations, especially for adhering to low energy substrates, such as polyethylene, polyethylene terephthalate, oriented polypropylene, polystyrene, cellulose acetate substrates, especially films, frequently encountered in packaging of foods and other commodities.

In some embodiments, the copolymer dispersion described herein can be used an adhesion promoter for a conventional vinyl ester/ethylene adhesive, for example a further copolymer dispersion prepared by free radical emulsion polymerization, such as a single stage free radical emulsion polymerization process, of a further monomer mixture comprising at least one vinyl ester of a C₁ to C₁₈ carboxylic acid and ethylene. In such as case, the multi-stage copolymer dispersion described herein may comprise from 5 to 50 wt % of the total weight of polymer dispersion employed in the adhesive composition.

When formulated into an adhesive, the aqueous copolymer dispersions described herein may be combined with additives which are typical for use in the production of dispersion-based adhesives. Typical additives include fillers, such as alkaline earth metal oxides, alkaline earth metal carbonates and/or silicates and tackifier resins, such as rosin ester, styrenated terpene, terpene phenolics. A typical adhesive formulation may therefore contain from 15 to 70 weight % of the present copolymer dispersion, from 0 to 50 weight % of a filler and from 5 to 50 weight % of a tackifier resin.

Other suitable additives include, for example, film-forming assistants, such as white spirit, Texanol®, TxiB®, butyl glycol, butyldiglycol, butyldipropylene glycol, and butyltripropylene glycol; wetting agents, such as AMP 90®, TegoWet.280®., Fluowet PE®; thickeners, such as polyacrylates or polyurethanes, such as Borchigel L759®. and Tafigel PUR 60®; defoamers, such as mineral oil defoamers or silicone defoamers; UV protectants, such as Tinuvin 1130®, subsequently added stabilizing polymers, such as polyvinyl alcohol or cellulose ethers, and other additives and auxiliaries of the kind typical for the formulation of adhesives.

The fraction of these additives in the final dispersion-based adhesive can be up to 25% by weight, preferably 2% to 15% by weight, and in particular 5% to 10% by weight, based on the dispersion.

As with other vinyl ester-based adhesive compositions, adhesives produced from the copolymer dispersions described herein can also contain external plasticizers, such as dimethyl phthalate, dibutyl phthalate, diisobutyl phthalate, diisobutyl adipate, Coasol B®, Plastilit 3060®, and Triazetin®. However, the use of such additives is frequently restricted in food contact applications and adhesive formulations containing the present copolymer dispersions generally exhibit excellent adhesive properties without the addition of plasticiziers. Thus, in many embodiments, adhesive formulations produced from the copolymer dispersions described herein are free of external plasticizers.

Adhesive formulations containing the present copolymer dispersions are particularly suitable for application to substrates by spraying.

Additional features of invention are presented in the following numbered paragraphs:

Paragraph 1. An adhesive composition comprising a copolymer dispersion prepared by a free radical emulsion polymerization process comprising:

(a) polymerizing, in a first stage, a first monomer composition comprising from 60 weight percent to 95 weight percent of at least one vinyl ester of a C₁ to C₁₈ carboxylic acid, and from 5 weight percent to 40 weight percent ethylene to produce a first polymer phase having a glass transition temperature T_{g} of less or equal than 30° C.; and

(b) polymerizing, in a second stage and in the presence of the first polymer phase, a second, different monomer composition comprising from 5 weight percent to 95 weight percent of at least one vinyl ester of a C₁ to C₁₈ carboxylic acid, and from 5 weight percent to 95 weight percent 2-ethylhexyl acrylate such that the polymer phase produced by the second monomer composition has a glass transition temperature T_{g} of less than or equal to 30° C.

Paragraph 2. An adhesive composition according to Paragraph 1, wherein the first monomer composition comprises from 15 weight percent to 40 weight percent ethylene.

Paragraph 3. An adhesive composition according to Paragraph 1 or Paragraph 2, wherein the first stage polymer has a glass transition temperature in the range of from −35° C. to 25° C., preferably from −35° C. to 10° C.

Paragraph 4. An adhesive composition according to any one of Paragraphs 1 to 3, wherein the second monomer composition comprises from 25 weight percent to 95 weight percent 2-ethylhexyl acrylate.

Paragraph 5. An adhesive composition according to any one of Paragraphs 1 to 4, wherein the second monomer composition further comprises from 0.05 weight percent to about 1.5 weight percent of at least one ethylenically unsaturated carboxylic acid.

Paragraph 6. An adhesive composition according to any one of Paragraphs 1 to 5, wherein the second polymer phase has a glass transition temperature in the range of from −70° C. to 25° C., preferably from −70° C. to 0° C.

Paragraph 7. An adhesive composition according to any one of Paragraphs 1 to 6, wherein the at least one vinyl ester of a C₁ to C₁₈ carboxylic acid in one or each of the first and second monomer compositions comprises vinyl acetate.

Paragraph 8. An adhesive composition according to any one of Paragraphs 1 to 7, wherein the first monomer composition comprises at least 75 weight percent of the total of the first and second monomer compositions.

Paragraph 9. An adhesive composition according to any one of Paragraphs 1 to 8, wherein each of the polymerizing steps is conducted in the presence of a stabilizing system comprising at least one protective colloid.

Paragraph 10. An adhesive composition according to Paragraph 9, wherein the at least one protective colloid comprises polyvinyl alcohol.

Paragraph 11. An adhesive composition according to any one of Paragraphs 1 to 10 and also comprising a further copolymer dispersion prepared by free radical emulsion polymerization of a further monomer mixture comprising at least one vinyl ester of a C₁ to C₁₈ carboxylic acid and ethylene.

Paragraph 12. Use of the adhesive composition according to any one of Paragraphs 1 to 11 in adhering a first substrate to a second substrate, wherein at least one of the first and second substrates comprises a low surface energy substrate.

Paragraph 13. Use of the adhesive composition according to any one of Paragraphs 1 to 11 in adhering a first substrate to a second substrate, wherein at least one of the first and second substrates comprises oriented polypropylene

The invention will now be more particularly described with reference to the following non-limiting Examples.

In the Examples, the solids content of the dispersions was measured by drying 1 to 2 g of the aqueous dispersion at 105° C. for 4 hours, then dividing the weight of dried polymer by the weight of dispersion, with the result expressed as a percentage.

Viscosity was determined at 25° C. using a Brookfield DV-I+ Viscometer, spindle 2, 3 or 4, speed 20 rpm.

Grit was determined by filtering 100 g of dispersion through a 40 μ filter, drying and weighing the dried grit. The grit is expressed as a percentage based on the weight of wet dispersion.

Adhesion to filmic substrates was determined as follows: The adhesive was coated on kraft paper, (80 gm⁻²), glossy side up, using a doctor blade, (75 μm, 5 mm wide). Films were glued to the kraft paper with the aid of a rubber roller and were left for 2 minutes under a 1 kg weight. The test pieces were stored for 24 hours at 23° C. The film strips were then pulled by hand from the kraft paper at two different speeds, (slow and fast). The fibre tear of the kraft paper is judged according to the following scale:
4=full surface tear
3=almost full-surface tear
2=some fibre tear
1=no fibre tear, but good adhesion
0=no adhesion

### EXAMPLE 1

### Comparative

Comparative Example 1 is Mowilith LDM 1081, a VAE dispersion stabilised by polyvinyl alcohol and emulsifier, containing approximately 26% ethylene, by weight, with a solids content of 52-55 wt %, a viscosity of 5000-9000 mPa.s and a Tg of −6° C., produced by Celanese.

### EXAMPLE 2

### Comparative

Comparative Example 2 was made following the procedure of Example 10 from U.S. Pat. No. 9,663,678 B2, a VAE dispersion containing 28% ethylene by weight, stabilized with 4.5 parts of polyvinyl alcohol and 0.67 parts of a nonionic surfactant. The resultant dispersion had a solids content of 56.0%, viscosity of 3270 mPa.s, and a Tg of −11.5° C.

### EXAMPLE 3

### Comparative

Comparative Example 3 is Example 13 from U.S. Pat. No. 9,663,678 B2, a VAE dispersion containing 32% ethylene by weight stabilized with 4.5 parts of polyvinyl alcohol and 0.67 parts of a nonionic surfactant, with a solids content of 55.8%, viscosity of 2700 mPa.s, and a Tg of −14.9° C.

### EXAMPLE 4

### Comparative

Comparative Example 4 was made following the procedure of Example 13 from U.S. Pat. No. 9,663,678 B2, except that the ethylene level was increased to 36% and the slow addition of vinyl acetate was extended to 180 minutes. The resultant dispersion had a solids content of 55.1%, viscosity of 3550 mPa.s, and a Tg of −21.8° C.

### EXAMPLE 5

### Comparative

An aqueous solution was prepared by addition of 207.3 g of a 25% aqueous solution of polyvinyl alcohol having a degree of hydrolysis of 87 to 89% and a Hoppler viscosity of a 4% aqueous solution of 4.0 to 5.0 mPa.s at 25° C., (Selvol E-4/88 LA, from Sekisui), 345.4 g of a 15% aqueous solution of polyvinyl alcohol having a degree of hydrolysis of 87 to 89% and a Hoppler viscosity of a 4% aqueous solution of 20 to 26 mPa.s at 25° C., (Selvol 523, from Sekisui), 185.0 g of a 70% active solution of an alcohol ethoxylate nonionic surfactant, (Emulsogen EPN 287 from Clariant), and 83.6 g of a 31% active solution of an ethoxylated sulphosuccinate monoester, (Rewopol SB FA 50 from Evonik), in 2850 g of deionized water while stirring. A solution of 1.35 g of Bruggolite FF6 in 51.8 g of deionized water was added, followed by 1.66 g of a defoamer, (Agitan 282), and 1.64 g of a 4% ferric chloride solution, then the pH was adjusted to pH 4.2 with phosphoric acid. Then the aqueous solution was charged to a 10-litre pressure reactor equipped with a stirrer, dosage pumps and a mass flow meter for dosing ethylene. The reactor was degassed by twice evacuating, then pressurizing with nitrogen to 2 bar, then finally evacuating.

1243.5 g of vinyl acetate was pumped into the reactor, then 932.6 g of ethylene was metered to the reactor and the temperature was adjusted to 36° C. When the reactor temperature stabilised at 36° C., the additions of an oxidiser solution comprising 14.8 g of 70% active t-butyl hydroperoxide dissolved in 196.5 g of deionised water and a reducer solution comprising 13.8 g of Bruggolite FF6, and 2.54 g of sodium bicarbonate dissolved in 202.0 g of deionized water were started at a rate of 36 g/hour. After detection of a temperature increase of 2° C., the jacket temperature was increased to 72° C. and the reaction controlled so that the internal reactor temperature reached 85° C. in 30 minutes.

At 80° C. the addition of 2072.5 g of vinyl acetate commenced to last 210 minutes. At 85° C. the addition of a further 932.6 g of ethylene was started with a pressure limit of 80 bar maximum pressure. The jacket temperature was maintained at 72° C. and the rates of oxidizer and reducer allowed to vary between 7.2 and 72 g/hour to keep the internal temperature at 85° C. When the internal temperature could no longer be maintained at a redox addition rate of 72 g/hour, the jacket temperature was allowed to increase.

After the additions of the oxidizer and reducer solutions were finished, the reactor was cooled to 55° C., and the contents transferred to a second vessel. When 50% had been transferred, a solution comprising 2.49 g of Brueggolite FF6, 1.66 g of Agitan 282 defoamer and 0.21 g of ammonium iron(II) sulphate hexahydrate in 123.06 g of deionised water was added over 5 minutes. Once all of the reactor contents were transferred and the pressure was below 1 bar, a solution comprising 3.55 g of t-butylhydroperoxide and 2.76 g of 30% active hydrogen peroxide in 134.72 g of deionised water was added, and the temperature was kept at 50° C. for 30 minutes. The vessel was cooled, the contents discharged, and the resultant dispersion was filtered through a 150 μ mesh. The resultant dispersion had a solids content of 55.0%, viscosity of 1560 mPa.s, pH of 5.8, grit (measured on a 40 μ mesh) of 0.003% and a Tg, (midpoint, by DSC), of −22.7° C.

### EXAMPLE 6

### Inventive

An aqueous solution was prepared by addition of 680.7 g of a 15% aqueous solution of polyvinyl alcohol having a degree of hydrolysis of 87 to 89% and a Hoppler viscosity of a 4% aqueous solution of 20 to 26 mPa.s at 25° C., (Selvol 523, from Sekisui), 145.9 g of a 70% active solution of an alcohol ethoxylate nonionic surfactant, (Emulsogen EPN 287 from Clariant), and 164.7 g of a 31% active solution of an ethoxylated sulphosuccinate monoester, (Rewopol SB FA 50 from Evonik), in 2624.1 g of deionized water while stirring. A solution of 1.33 g of Bruggolite FF6 in 51.1 g of deionized water was added, followed by 1.63 g of a defoamer, (Agitan 282), and 1.66 g of a 4% ferric chloride solution, then the pH was adjusted to pH 4.2 with phosphoric acid. Then the aqueous solution was charged to a 10-litre pressure reactor equipped with a stirrer, dosage pumps and a mass flow meter for dosing ethylene. The reactor was degassed by twice evacuating, then pressurizing with nitrogen to 2 bar, then finally evacuating.

1225.3 g of vinyl acetate was pumped into the reactor, then 919.0 g of ethylene was metered to the reactor and the temperature was adjusted to 36° C. When the reactor temperature stabilised at 36° C., the additions of an oxidiser solution comprising 14.6 g of 70% active t-butyl hydroperoxide dissolved in 193.6 g of deionised water and a reducer solution comprising 13.6 g of Bruggolite FF6, and 2.50 g of sodium bicarbonate dissolved in 199.1 g of deionized water were started at a rate of 35 g/hour. After detection of a temperature increase of 2° C., the jacket temperature was increased to 72° C. and the reaction controlled so that the internal reactor temperature reached 85° C. in 30 minutes.

At 80° C. the addition of 1582.6 g of vinyl acetate commenced to last 150 minutes. At 85° C. the addition of a further 612.6 g of ethylene was started with a pressure limit of 80 bar maximum pressure. The jacket temperature was maintained at 72° C. and the rates of oxidizer and reducer allowed to vary between 7.2 and 72 g/hour to keep the internal temperature at 85° C. When the internal temperature could no longer be maintained at a redox addition rate of 72 g/hour, the jacket temperature was allowed to increase. The additions of the redox solutions were continued until 80% of the total had been added.

The reactor was cooled to an internal temperature of 60° C. and maintained at that temperature. A mixture comprising 204.2 g of vinyl acetate, 510.5 g of 2-ethylhexyl acrylate and 51.1 g of acrylic acid was added over 15 minutes. Then the remaining 20% of the redox solutions was added over 30 minutes. After the additions of the oxidizer and reducer solutions were finished, the reactor was cooled to 50° C., and the contents transferred to a second vessel. When 50% had been transferred, a solution comprising 2.45 g of Brueggolite FF6, 1.63 g of Agitan 282 defoamer and 0.20 g of ammonium iron(II) sulphate hexahydrate in 121.25 g of deionised water was added over 5 minutes. Once all of the reactor contents were transferred and the pressure was below 1 bar, a solution comprising 3.50 g of t-butylhydroperoxide and 2.72 g of 30% active hydrogen peroxide in 132.7 g of deionised water was added, and the temperature was kept at 50° C. for 30 minutes. The vessel was cooled, the contents discharged, and the resultant dispersion was filtered through a 150 μ mesh. The resultant dispersion had a solids content of 54.9%, viscosity of 6100 mPa.s, pH of 4.7, grit, (measured on a 40 μ mesh), of 0.004% and a Tg, (midpoint, by DSC), of −21.5° C.

### EXAMPLE 7

### Adhesion Testing

The dispersions of Examples 1 to 7 were tested as described above, as made and also plasticized with an addition of 10% Benzoflex 2088, (Eastman), a mixture of benzoate esters. The filmic substrates used were: OPP, (Trespaphan GND 35), PET, (Hostaphan RN 50), PVC, (Genotherm GA 66), CA, (Cellulose Acetate N 50) and PS, (Norflex 50p). The results are shown in Table 1.

TABLE 1

| | OPP | PET | PVC | CA | PS |
|---|---|---|---|---|---|
| Example 1 unplasticised/plasticised | 0/1 | 0/1 | 1/4 | 4/4 | 0/1 |
| Example 2 unplasticised/plasticised | 1/1 | 0/1 | 4/4 | 4/4 | 0/2 |
| Example 3 unplasticised/plasticised | 0/1 | 0/0 | 2/4 | 4/4 | 0/0 |
| Example 4 unplasticised/plasticised | 1/1 | 1/3 | 4/4 | 4/4 | 1/4 |
| Example 5 unplasticised/plasticised | 1/1 | 4/4 | 4/4 | 4/4 | 4/4 |
| Example 6 unplasticised/plasticised | 4/4 | 4/4 | 4/4 | 4/4 | 4/4 |

The results show that the dispersion of Inventive Example 6 exhibits superior adhesion to all the filmic substrates tested, and especially the oriented polypropylene (OPP), than the dispersions of Comparative Examples 1 to 5, even in the absence of added plasticizer.

### EXAMPLE 8

### Inventive

The procedure of Example 6 was followed except that the level of anionic surfactant was halved to 0.5 pphm on an active basis and the level of nonionic surfactant was increased by 25% to 2.5 pphm on an active basis. The resultant dispersion had a solids content of 54.7%, viscosity of 6060 mPa.s, pH of 4.7, grit (measured on a 40 μ mesh) of 0.009% and a Tg, (midpoint, by DSC), of −22.4° C.

### EXAMPLE 9

### Inventive

The procedure of Example 8 was followed, except that the levels of t-butyl hydroperoxide and Brüggolite FF6 were increased by 25%, and 75% of the initiators were used for polymerizing the VAE phase. The second phase monomer mixture comprising vinyl acetate, 2-ethyl hexyl acrylate and acrylic acid was added over 60 minutes and the final 25% of the initiators was added over 90 minutes, with both additions starting simultaneously. The resultant dispersion had a solids content of 54.7%, viscosity of 2820 mPa.s, pH of 4.5, grit (measured on a 40 μ mesh) of 0.02% and a Tg, (midpoint, by DSC), of −20.7° C.

### EXAMPLE 10

### Inventive

The procedure of Example 9 was followed except that 75% of the Selvol 523 was replaced by a polyvinyl alcohol having a degree of hydrolysis of 87 to 89% and a Hoppler viscosity of a 4% aqueous solution of 4 to 5 mPa.s at 25° C., (Selvol E-4/88 LA from Sekisui). The resultant dispersion had a solids content of 54.4%, viscosity of 710 mPa.s, pH of 5.0, grit (measured on a 40 μ mesh) of 0.03% and a Tg, (midpoint, by DSC), of −21.4° C.

### EXAMPLE 11

### Inventive

The procedure of Example 9 was followed except that the polyvinyl alcohol was replaced by an equal weight of hydroxyethyl cellulose and the addition times of the second phase monomers and initiator solutions were reduced to 30 minutes and 75 minutes respectively. The resultant dispersion had a solids content of 55.2%, viscosity of 4250 mPa.s, pH of 4.5, grit (measured on a 40 μ mesh) of 0.1% and a Tg, (midpoint, by DSC), of −21.8° C.

### EXAMPLE 12

### Inventive

The procedure of Example 11 was followed, except that the level of hydroxyethyl cellulose was reduced by 50% to 1.0 pphm active, the level of the anionic surfactant was doubled to 1.0 pphm active and the level of nonionic surfactant was increased by 20% to 3.0 pphm active. The resultant dispersion had a solids content of 55.1%, viscosity of 2585 mPa.s, pH of 4.4, grit (measured on a 40 μ mesh) of 0.02% and a Tg, (midpoint, by DSC), of −20.4° C.

### EXAMPLE 13

### Inventive

The procedure of Example 12 was followed except that the hydroxyethyl cellulose was replaced by an equal weight of polyvinyl alcohol, (Selvol 523). The resultant dispersion had a solids content of 54.8%, viscosity of 2010 mPa.s, pH of 4.7, grit (measured on a 40 μ mesh) of 0.02% and a Tg, (midpoint, by DSC), of −22.2° C.

### EXAMPLE 14

### Inventive

Examples 8 to 13 were tested using the procedure of Example 7. All of the Examples gave full surface tear with each of the 5 substrates.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. An adhesive composition comprising a copolymer dispersion prepared by a free radical emulsion polymerization process comprising:
(a) polymerizing, in a first stage, a first monomer composition comprising from 60 weight percent to 95 weight percent of at least one vinyl ester of a C₁ to C₁₈ carboxylic acid, and from 5 weight percent to 40 weight percent ethylene to produce a first polymer phase having a glass transition temperature T_{g} of less or equal than 30° C.; and
(b) polymerizing, in a second stage and in the presence of the first polymer phase, a second, different monomer composition comprising from 5 weight percent to 95 weight percent of at least one vinyl ester of a C₁ to C₁₈ carboxylic acid, and from 5 weight percent to 95 weight percent 2-ethylhexyl acrylate such that the polymer phase produced by the second monomer composition has a glass transition temperature T_{g} of less than or equal to 30° C.

2. An adhesive composition according to claim 1, wherein the first monomer composition comprises from 15 weight percent to 40 weight percent ethylene.

3. An adhesive composition according to claim 1, wherein the first stage polymer has a glass transition temperature in the range of from −35° C. to 25° C.

4. An adhesive composition according to claim 1, wherein the first stage polymer has a glass transition temperature in the range of from −35° C. to 10° C.

5. An adhesive composition according to claim 1, wherein the second monomer composition comprises from 25 weight percent to 95 weight percent 2-ethylhexyl acrylate.

6. An adhesive composition according to claim 1, wherein the second monomer composition further comprises from 0.05 weight percent to about 1.5 weight percent of at least one ethylenically unsaturated carboxylic acid.

7. An adhesive composition according to claim 1, wherein the second polymer phase has a glass transition temperature in the range of from −70° C. to 25° C.

8. An adhesive composition according to claim 1, wherein the second polymer phase has a glass transition temperature in the range of from −70° C. to 0° C.

9. An adhesive composition according to claim 1, wherein the at least one vinyl ester of a C₁ to C₁₈ carboxylic acid in one or each of the first and second monomer compositions comprises vinyl acetate.

10. An adhesive composition according to claim 1, wherein the first monomer composition comprises at least 75 weight percent of the total of the first and second monomer compositions.

11. An adhesive composition according to claim 1, wherein each of the polymerizing steps is conducted in the presence of a stabilizing system comprising at least one protective colloid.

12. An adhesive composition according to claim 11, wherein the at least one protective colloid comprises polyvinyl alcohol.

13. An adhesive composition according to claim 1 and also comprising a further copolymer dispersion prepared by free radical emulsion polymerization of a further monomer mixture comprising at least one vinyl ester of a C₁ to C₁₈ carboxylic acid and ethylene.

14. A process of adhering a first substrate to a second substrate, wherein at least one of the first and second substrates comprises a low surface energy substrate, the process comprising applying to at least one of the substrates an adhesive composition according to claim 1.

15. The process of claim 14, wherein at least one of the first and second substrates comprises oriented polypropylene.
